(19) United States
(12) Patent Application Publication
(10) Pub. No.: US 2006/0005223 A1
(43) Pub. Date: Jan. 5, 2006

(54) Method of recording and playing video at optimized resolution

(76) Inventors: Yung-Chiuan Weng, Taipei Hsien (TW); Chia-Ho Lin, Taipei Hsien (TW)

Correspondence Address: HARNESS, DICKEY & PIERCE, P.L.C., P.O. BOX 8910, RESTON, VA, 20195, US

(21) Appl. No.: 10/880,647

(22) Filed: Jul. 1, 2004

(51) Int. Cl. H04N 7/173; H04N 7/16

(52) U.S. Cl. 725/89; 725/134; 725/142

(57) ABSTRACT

A method of recording and playing video at an optimized resolution is disclosed. By automatic detection of the resolutions of a display device and an original video, the method determines an optimized resolution for recording and playing video. By this method can satisfy the highest playing requirements of the display device and therefore provide the highest video playing quality to the user. When recording video, the method simultaneously records stream files of the standard resolution and the maximum resolution in different streams. When playing the video, the method also selects the most appropriate stream file according to the resolution data and plays it.

### BACKGROUND OF THE INVENTION

1. Field of Invention

The invention relates to a video recording and playing method implemented in computer software. In particular, the invention relates to a method of recording and playing video at an optimized resolution automatically according to the resolutions of a display device and an original video.

2. Related Art

As the burning technology becomes mature and there are increasing demands for multimedia applications, the conventional analog video recording technique is no longer satisfactory for many video players. Instead, the DVD video recording technology of the digital versatile disc or digital video disc (DVD) has become popular.

However, the digital video playing is often limited by the insufficient playing and display functions of many commercial products on the market. Therefore, the high resoluton digital video cannot be fully appreciated by such products. As a result, common users may consider lower resolutions in recording video in order to match the playing and display quality of normal commercial products. However, this may cause the information loss in the original video. Once the user has a device with better playing and display functions, it is still impossible to play the video at a better quality because the resolution has been sacrificed.

Consequently, it is highly desirable to use the currently prosperous computer software technology to develop a method that can intelligently record video data with different resolutions in the recording medium in order to satisfy playing and displaying devices at various levels. The users can therefore enjoy video contents at an optimized resolution. This is believed to be the mainstream in the field of digital audio-video (AV) recording technology in the near future.

### SUMMARY OF THE INVENTION

In view of the foregoing, the invention provides a method of recording and playing video at an optimized resolution. Its primary objective is to achieve resolution optimization when recording video data through intelligent determination of the resolutions of a display device and an original video. At the same time of copying the stream file with the standard resolution, another stream file with an optimized resolution is recorded, too. When playing the video stored in the recording medium, the stream file with the most appropriate resolution is extracted for display. Therefore, the invention can satisfy different display devices and different needs of users.

To achieve the above objective, the system implemented with the disclosed method includes: an operating module, an extracting module, a playing module, and a recording module.

The disclosed method includes the steps of: selecting a source video file to start a recording procedure, extracting the maximum resolution of a display device, detecting the maximu resolution of the source video file, determining a final recording resolution, starting the recording procedure on a recording medium.

In a preferred embodiment of the invention, the disclosed method further includes the steps of: selecting a recording medium to start a playing procedure, reading the resolution data of the video data, extracting the maximum display resolution of the display device, comparing the maximum display resolution with the resolution data, and playing the stream file after the comparison.

### BRIEF DESCRIPTION OF THE DRAWINGS

The invention will become more fully understood from the detailed description given hereinbelow illustration only, and thus are not limitative of the present invention, and wherein:

FIG. 1 shows the operation of the disclosed method of recording and playing video at an optimized resolution;

FIG. 2a is a flowchart of video recording according to the disclosed method;

FIG. 2b is another flowchart of video recording according to the disclosed method; and

FIG. 3 is a flowchart of video playing according to the disclosed method.

### DETAILED DESCRIPTION OF THE INVENTION

The specification discloses a video recording and playing method with an optimized resolution. Through intelligent determination of the resolutions of a display device and an original video, an optimized recording resolution is found. In addition to copying the stream file with the standard resolution, the invention also records the stream file with the optimized resolution. When playing the video on the recording medium, the invention compares the identification data in each of the stream files and finds a most appropriate stream file that has the best quality on the display device. Therefore, the invention can satisfy all display devices and different playing needs of users.

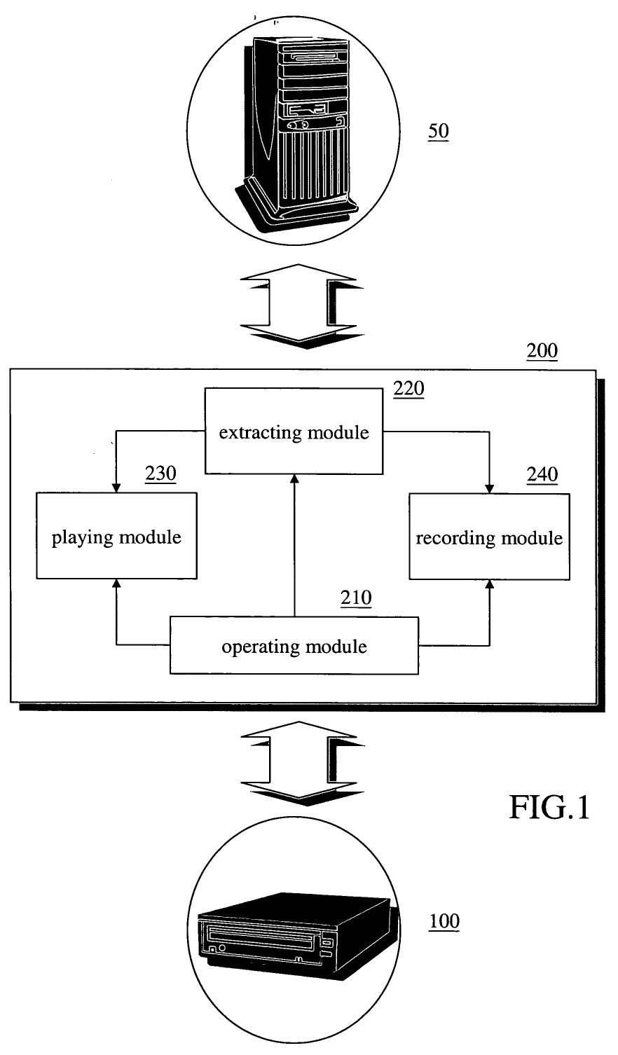

In the following, we use FIG. 1 to explain the system structure of the invention. The disclosed system 200 is between a computer executable platform 50 and a recording medium 100. It is used to automatically find an optimized resolution when recording and playing video. Its basic structure contains: an operating module 210, an extracting module 220, a playing module 230, and a recording module 240.

(1) The operating module 210 is used to generate a user interface (UI) that provides a menu of various functions for the user to perform operations during video recording and playing. Such operations include: selecting a source video file, setting parameters for recording, executing the recording procedure, setting parameters for playing, and executing the playing procedure.

(2) The extracting module 220 extracts a source video file for recording from the computer executable platform 50. During the playing procedure, the extracting module 220 extracts a stream file to be played from the recording medium 100.

(3) The playing module 230 checks the identification data (e.g. title and resolution) in each of the stream files according to the user's operations. According to the display power of the display device on the computer executable platform 50, the playing module 230 selects a stream file with the optimized quality to play.

(4) The recording module 240 performs the recording procedure with the optimized quality according to the display power of the display device on the computer executable platform 50 and the resolution of the source video file that the user wants to copy. In fact, in addition to performing optimized recording, the recording module 240 further has the function of recording using the standard resolution (usually 720*480 pixels) in order to ensure that the recorded video can be played on all display devices.

Moreover, the disclosed video recording and playing system 200 allows the user to assign a recording resolution through the UI. Therefore, in addition to the standard resolution recording, the optimized resolution recording, the user also has the choice of the customized resolution recording.

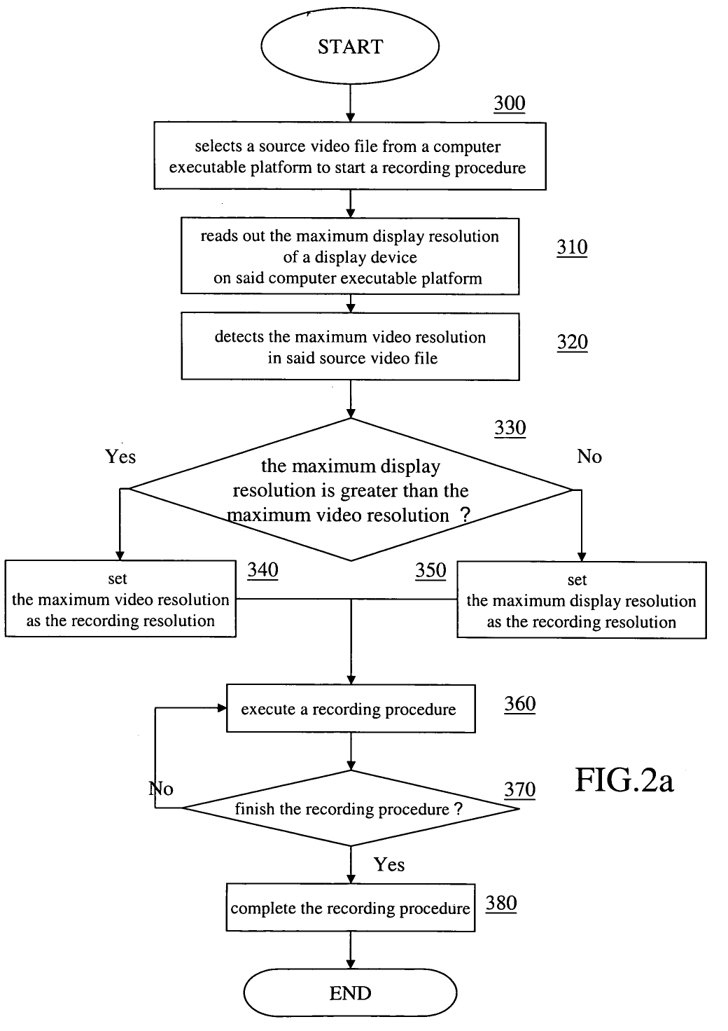

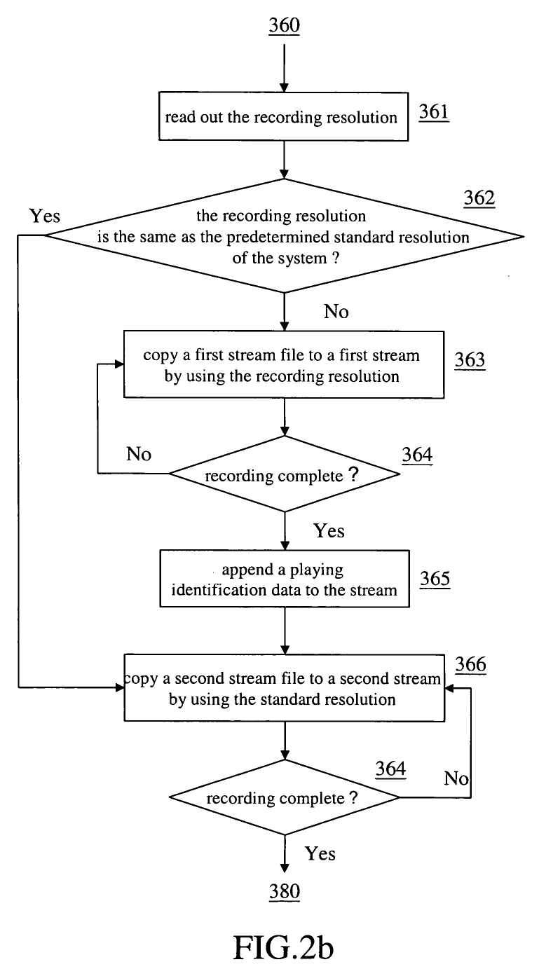

We use FIGS. 2a and 2b to explain the procedure of video recording in accord with the invention. First, a user selects a source video file from a computer executable platform 50 to start a recording procedure (step 300). The system reads out the maximum display resolution of the display device on the computer executable platform 50 (step 310). Afterwards, the system detects the maximum video resolution in the source video file selected by the user (step 320). After obtaining the values in steps 310 and 320, the system makes a comparison to see if the maximum display resolution is greater than the maximum video resolution (step 330). If the former is larger, the display power is better than the quality of the source video file. The system then takes the maximum video resolution of the source video file as the recording resolution (step 340). Otherwise, the display power of the display device is worse, and the system uses the maximum display resolution of the display device as the recording resolution (step 350). Once the recording resolution is determined, the system executes a recording procedure (step 360), whose detailed steps are shown in FIG. 2b to be explained later. During the recording process, the system keeps checking if the recording is done (step 370). If not, then the system keeps executing step 360. Otherwise, the recording procedure is completed (step 380).

When executing the recording procedure (see FIG. 2b), the system first reads out the recording resolution (step 361) and then determines whether the recording resolution is the same as the predetermined standard resolution of the system (step 362). If they are different, the system has to perform the optimized resolution recording and the standard resolution recording at the same time. The system copies a stream file to the stream using the recording resolution (i.e. the optimized resolution) (step 363) and checks whether the recording is complete (step 364). If not, the procedure stays at step 363; otherwise, the completed stream file is appended with playing identification data (step 365). Afterwards, another stream file is recorded to another stream according to the standard resolution (step 366). Likewise, step 366 is repeated until the recording is completed and goes to step 380. If the recording resolution is the same as the standard resolution in step 362, there is no need for the optimized resolution recording and the system continues to step 366 directly for standard resolution recording.

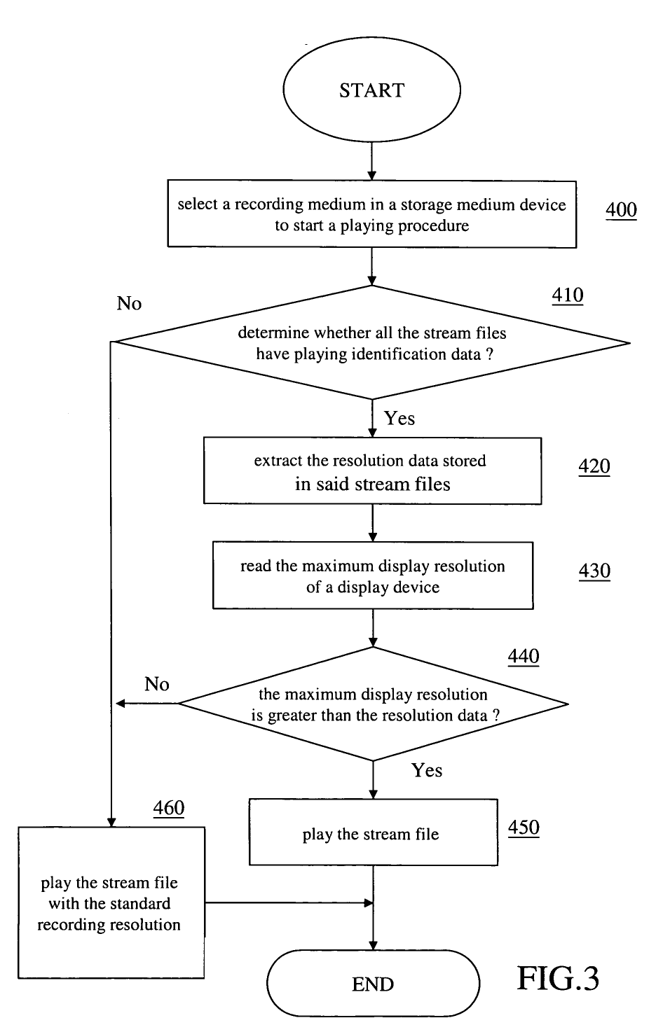

Finally, we use FIG. 3 to explain the video playing procedure. First, a user selects a recording medium in a storage medium device 100 to start a playing procedure (step 400). The system determines whether all the stream files in the storage medium device have playing identification data (step 410). If there are, the system further extracts the resolution data stored therein (step 420). The resolution data mainly contains the optimized playing resolution of the stream file. The system then reads the maximum display resolution of a display device (step 430). After the two resolution data are obtained, the system compares them (step 440). If the maximum display resolution is greater than the resolution data in the stream file, the display device has the ability to display the stream file and the system plays the stream file (step 450). Otherwise, the display device does not have sufficient display power, and the system plays the stream file with the standard recording resolution (step 460) and ends the video playing procedure. Likewise, if the system cannot fina any stream file with playing identification data in step 410, it jumps to step 460 to play the stream file with the standard resolution.

### EFFECTS OF THE INVENTION

The disclosed video recording and playing method with an optimized resolution can automatically find an optimized resolution between a display device and a source video. It generates an optimized stream file with a resolution higher than the standard one on a storage medium. Therefore, the source video will not be over-compressed to have distortion.

When playing the storage medium, the playing identification data in the stream file helps optimizing the playing effects according to the specification of the display device. The user can enjoy the best video quality available.

Certain variations would be apparent to those skilled in the art, which variations are considered within the spirit and scope of the claimed invention.

What is claimed is:

1. A resolution optimized video recording and playing system implemented in computer software for finding an optimized resolution from a display device of a computer executable platform and a source video to record and play video, the system comprising:
an operating module, which generates a user interface (UI) for a user to perform operations of video recording and playing;
an extracting module, which extracts a source video file for recording from the computer executable platform per the user's operation and extracts the source video file for playing from a storage medium;
a playing module, which uses playing identification data and the display ability of the display device to find a stream file with an optimized quality per the user's operation; and
a recording module, which records the stream file at the optimized resolution according to the display ability of the display device and the source video file resolution per the user's operation.

2. The system of claim 1, wherein the storage medium is randomly accessible and installed in a storage medium device for executing the video recording and playing procedures.

3. The system of claim 1, wherein the playing module plays the stream file with the standard recording resolution when the maximum resolution of the display device is smaller than the resolution data of the stream file.

4. The system of claim 1, wherein the playing identification data contain a title and a resolution.

5. The system of claim 1, wherein the recording module takes the smaller one of the maximum resolution of the display device and the maximum video resolution of the source video file as a final recording resolution.

6. A resolution optimized video recording method implemented in computer software for finding an optimized resolution from a display device of a computer executable platform and a source video to record and play video, the method comprising the steps of:
selecting a source video file to start a recording procedure;
extracting the maximum resolution of a display device;
detecting a maximum video resolution of the source video file;
determining a recording resolution; and
performing a recording procedure of a storage medium.

7. The method of claim 6, wherein the recording resolution is the smaller one of the maximum display resolution and the maximum video resolution.

8. The method of claim 6, wherein the storage medium is randomly accessible and installed in a storage medium device for executing the video recording and playing procedures.

9. The method of claim 6, wherein the step of performing the recording procedure further contains the steps of:
reading the recording resolution;
recording a first stream file to a first stream according to the recording resolution;
appending playing identification data t the first stream file;
recording a second stream file to a second stream according to a standard resolution; and
completing the recording procedure.

10. The method of claim 6 further comprising the step of performing a customized recording procedure according to the video resolution assigned by the user.

11. A resolution optimized video playing method implemented in computer software for finding an optimized resolution from a display device of a computer executable platform and a source video to record and play video, the method comprising the steps of:
selecting a storage medium to start a playing procedure;
reading a resolution from the playing identification data;
extracting the maximum display resolution of the display device;
comparing the maximum display resolution and the resolution data; and
playing a stream file.

12. The method of claim 11, wherein the recording resolution is the smaller one of the maximum display resolution and the maximum video resolution.

13. The method of claim 11 further comprising the step of playing the stream file with a standard recording resolution when the maximum display resolution is smaller than the resolution data.
